(19) United States
(12) Patent Application Publication
(10) Pub. No.: US 2023/0248149 A1
(43) Pub. Date: Aug. 10, 2023

(54) CABINET ENCLOSURE AND CABINET DOOR WITH EXPANSION GAPS AND RELATED METHODS

(71) Applicant: Melbourne Architectural Millwork Company, Melbourne, FL (US)

(72) Inventor: Thomas Soyk, Melbourne, FL (US)

(21) Appl. No.: 18/165,583

(22) Filed: Feb. 7, 2023

Related U.S. Application Data
(60) Provisional application No. 63/307,366, filed on Feb. 7, 2022.

(51) Int. Cl. A47B 96/20; E06B 5/00

(52) U.S. Cl. CPC A47B 96/20; E06B 5/006

(57) ABSTRACT

A cabinet door includes a center panel with a flat member, and rods extending outwardly from first and second sides, and first and second ends. The cabinet door includes first and second stiles extending vertically and respectively receiving the rods extending from the first and second sides of the center panel. The first stile and the first side of the center panel define a first stile expansion gap, and the second stile and the second side of the center panel define a second stile expansion gap. The cabinet door also includes first and second rails extending horizontally and respectively receiving the rods extending from the first and second ends of the center panel. The first rail and the first end of the center panel define a first rail expansion gap, and the second rail and the second end of the center panel defining a second rail expansion gap.

### RELATED APPLICATION

This application is based upon prior filed copending Application No. 63/307,366 filed Feb. 7, 2022, the entire subject matter of which is incorporated herein by reference in its entirety.

### TECHNICAL FIELD

The present disclosure relates to the field of cabinetry, and, more particularly, to outdoor cabinetry and related methods.

### BACKGROUND

The need for outdoor cabinetry has increased significantly over time with increased demand for summer kitchens and other outdoor spaces requiring storage. Outdoor cabinetry solutions that are currently in use suffer from a series of problems including poor durability because outdoor environments cause the cabinetry to deteriorate rapidly. Causes for the deterioration include large variations in heat and cold, humidity and sunlight exposure and other outdoor exposure issues, all of which can cause outdoor cabinetry to deteriorate far more rapidly than similar cabinetry would indoors. Various solutions have been attempted to reduce deterioration. One solution is to reduce the complexity of the outdoor storage, including eliminating cabinet doors and other features of the outdoor furniture to reduce the number of areas where the outdoor storage may fail. However, outdoor storage without cabinet doors results in the stored items being subjected to weather conditions that will cause the stored items to deteriorate more rapidly. These attempts to avoid wear and tear also result in in much less attractive storage space.

### SUMMARY

Generally, a cabinet enclosure comprises a cabinet housing defining a cavity therein and having first and second end panels, and a back panel coupled to the first and second end panels. The cabinet enclosure also includes at least one cabinet door coupled to the first and second end panels opposite the back panel and providing access to the cavity. The at least one cabinet door comprises a center panel comprising a flat member having first and second sides, and first and second ends extending between the first and second sides, and a plurality of rods extending outwardly from the first and second sides, and the first and second ends. The at least one cabinet door further includes first and second stiles extending vertically and respectively receiving the plurality of rods extending from the first and second sides of the center panel. The first stile and the first side of the center panel define a first stile expansion gap therebetween, and the second stile and the second side of the center panel define a second stile expansion gap therebetween. The at least one cabinet door also includes first and second rails extending horizontally and respectively receiving the plurality of rods extending from the first and second ends of the center panel. The first rail and the first end of the center panel define a first rail expansion gap therebetween, and the second rail and the second end of the center panel define a second rail expansion gap therebetween.

More specifically, each of the first and second stiles may define a stile longitudinal slot on a periphery thereof for receiving the plurality of rods extending from the first and second sides of the center panel. Each of the first and second rails may define a rail longitudinal slot on a periphery thereof for receiving the plurality of rods extending from the first and second ends of the center panel.

Each of the first and second rails may comprise a flat rail member, and a plurality of rail rods extending outwardly therefrom. Each of the first and second stiles may define a plurality of blind passageways on a periphery thereof, the plurality of blind passageways receiving the plurality of rail rods. In some embodiments, the at least one cabinet door may comprise an adhesive material between the first and second rails and the first and second stiles. For example, each of the first stile expansion gap, the second stile expansion gap, the first rail expansion gap, and the second rail expansion gap may be about 1 mm in width. The first and second stiles, and the first and second rails may be coupled to the center panel without an adhesive material. The first and second stiles, the first and second rails, and the center panel may comprise a moisture absorbing material.

Another aspect is directed to a cabinet door to be coupled to a cabinet enclosure and providing access to a cavity for the cabinet enclosure. The cabinet door comprises a center panel comprising a flat member having first and second sides, and first and second ends extending between the first and second sides, and a plurality of rods extending outwardly from the first and second sides, and the first and second ends. The cabinet door also includes first and second stiles extending vertically and respectively receiving the plurality of rods extending from the first and second sides of the center panel. The first stile and the first side of the center panel define a first stile expansion gap therebetween, and the second stile and the second side of the center panel define a second stile expansion gap therebetween. The cabinet door also includes first and second rails extending horizontally and respectively receiving the plurality of rods extending from the first and second ends of the center panel. The first rail and the first end of the center panel define a first rail expansion gap therebetween, and the second rail and the second end of the center panel define a second rail expansion gap therebetween.

Yet another aspect is directed to a method of making a cabinet door to be coupled to a cabinet enclosure and providing access to a cavity for the cabinet enclosure. The method comprises forming a center panel comprising a flat member having first and second sides, and first and second ends extending between the first and second sides, and a plurality of rods extending outwardly from the first and second sides, and the first and second ends. The method also includes forming first and second stiles extending vertically and respectively receiving the plurality of rods extending from the first and second sides of the center panel. The first stile and the first side of the center panel define a first stile expansion gap therebetween, and the second stile and the second side of the center panel define a second stile expansion gap therebetween. The method comprises forming first and second rails extending horizontally and respectively receiving the plurality of rods extending from the first and second ends of the center panel. The first rail and the first end of the center panel define a first rail expansion gap therebetween, and the second rail and the second end of the center panel define a second rail expansion gap therebetween.

### BRIEF DESCRIPTION OF THE DRAWINGS

FIG. 1 is a schematic top plan view of a cabinet enclosure, according to a first embodiment of the present disclosure.

FIG. 2 is a schematic exploded view of the cabinet door from the cabinet enclosure of FIG. 1.

FIG. 3 is a schematic front view of the cabinet door from the cabinet enclosure of FIG. 1.

FIG. 4 is a schematic side view of either the first stile or the second stile in the cabinet door from the cabinet enclosure of FIG. 1.

FIG. 5 is a schematic side view of either the first rail or the second rail in the cabinet door from the cabinet enclosure of FIG. 1.

FIG. 6 is a schematic exploded view of the cabinet door from a cabinet enclosure, according to a second embodiment of the present disclosure.

FIG. 7 is a perspective view of a cabinet enclosure, according to a third embodiment of the present disclosure.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

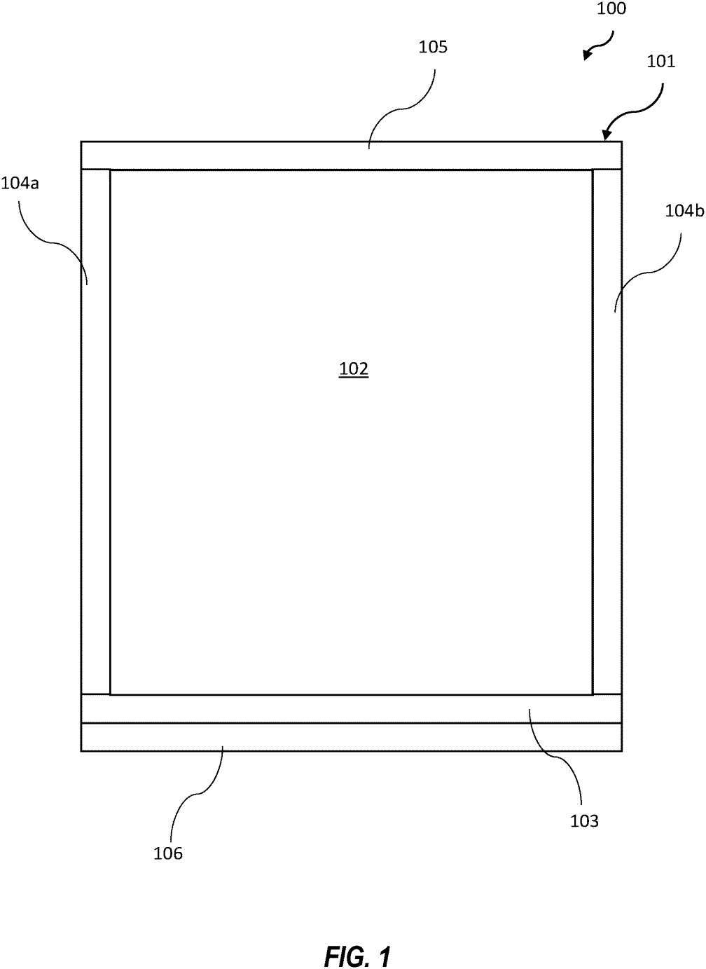

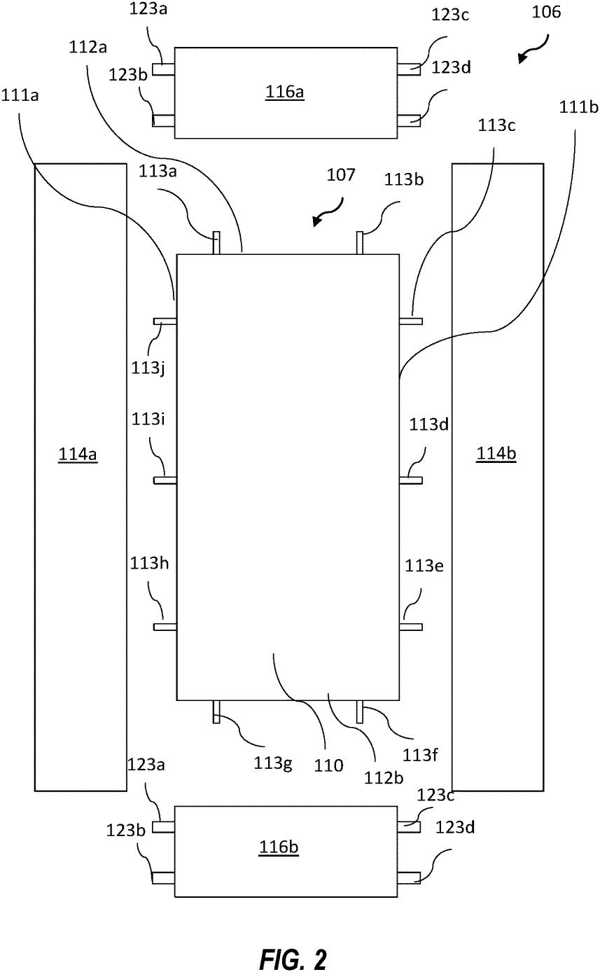

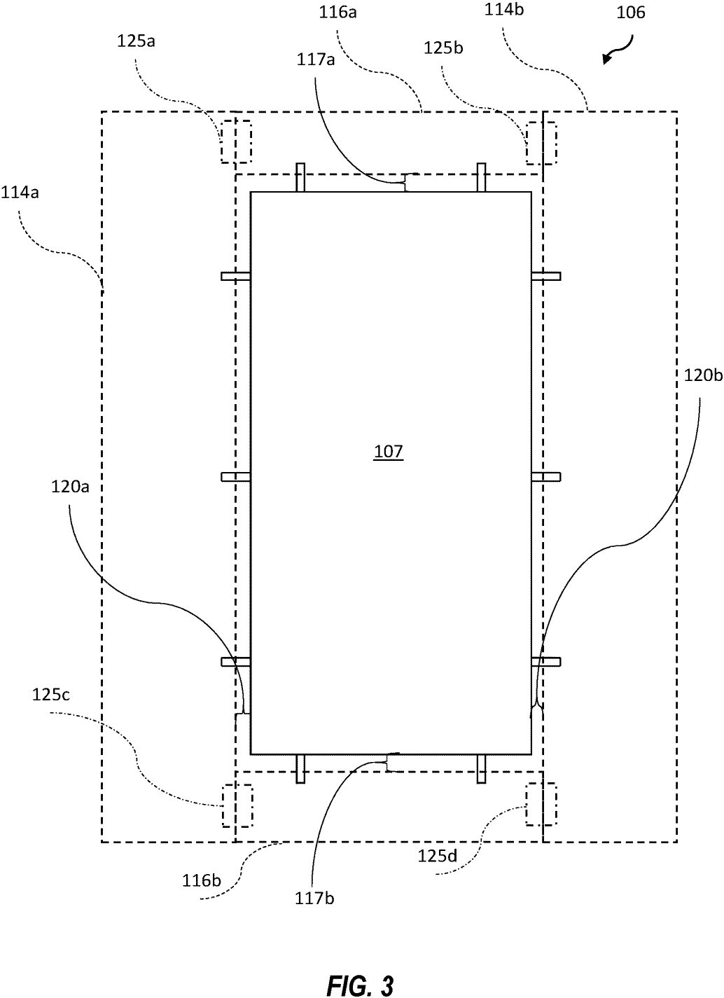

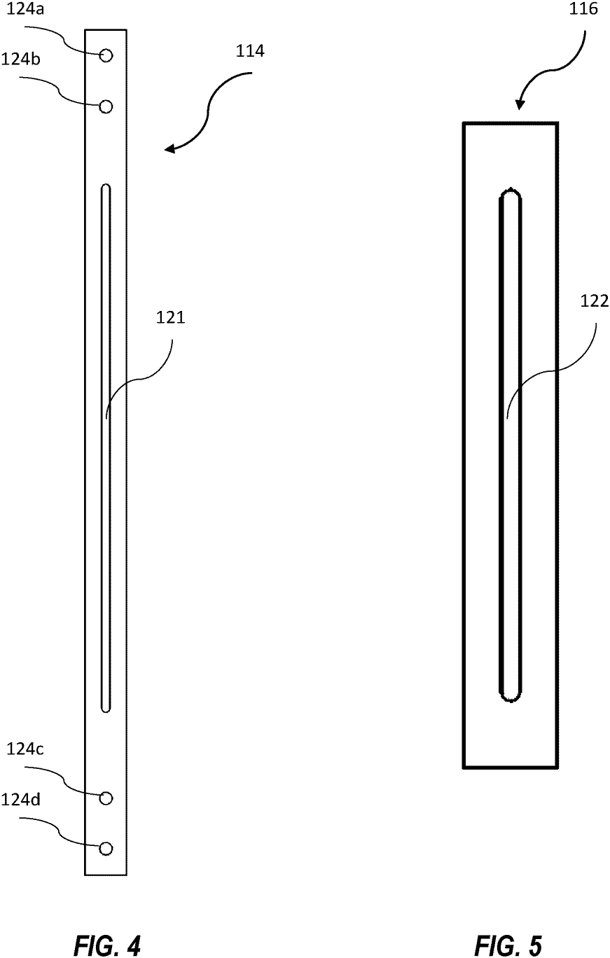

Referring initially to FIGS. 1-5, a cabinet enclosure 100 according to the present disclosure is now described. The cabinet enclosure 100 illustratively comprises a cabinet housing 101 defining a cavity 102 therein and having a face frame 103, first and second end panels 104a-104b coupled to the face frame, and a back panel 105 coupled to the first and second end panels opposite the face frame. The cabinet enclosure 100 also includes a cabinet door 106 coupled to the face frame 103 and providing access to the cavity 102. Of course, in some embodiments, the face frame 103 may be omitted, and the cabinet door 106 may be coupled directly to the first and second end panels 104a-104b (i.e. European faceless style).

The cabinet door 106 comprises a center panel 107 comprising a flat member 110 having first and second sides 111a-111b, and first and second ends 112a-112b extending between the first and second sides, and a plurality of rods 113a-113j (e.g. wood/plastic/metallic dowels, biscuits of 8 mm length) extending outwardly from the first and second sides, and the first and second ends. It should be appreciated that the center panel 107 may comprise a flat plain panel, or a panel with ornamentation on the front thereof. The cabinet door 106 further includes first and second stiles 114a-114b extending vertically and respectively receiving the plurality of rods 113a-113j extending from the first and second sides 111a-111b of the center panel 107.

The first stile 114a and the first side 111a of the center panel 107 define a first stile expansion gap 115a therebetween, and the second stile 114b and the second side 111b of the center panel define a second stile expansion gap 115b therebetween. The cabinet door 106 also includes first and second rails 116a-116b extending horizontally and respectively receiving the plurality of rods 113a-113j extending from the first and second ends 112a-112b of the center panel 107. The first rail 116a and the first end 112a of the center panel 107 define a first rail expansion gap 117a therebetween, and the second rail 116b and the second end 112b of the center panel define a second rail expansion gap 117b therebetween.

Each of the first and second stiles 114a-114b defines a stile longitudinal slot 120 on a periphery thereof for receiving the plurality of rods 113a-113j extending from the first and second sides 111a-111b of the center panel 107. In some embodiments, each of the first and second stiles 114a-114b defines a plurality of aligned spaced apart stile longitudinal slots on a periphery thereof. More specifically, each of the plurality of aligned stile longitudinal slots has a length of about 3 times the diameter of an individual rods 113a-113j.

Each of the first and second rails 116a-116b defines a rail longitudinal slot 121 on a periphery thereof for receiving the plurality of rods 113a-113j extending from the first and second ends 112a-112b of the center panel 107. In some embodiments, each of the first and second rails 116a-116b defines a plurality of aligned spaced apart rail longitudinal slots on a periphery thereof. More specifically, each of the plurality of aligned rail longitudinal slots has a length of about 3 times the diameter of an individual rods 113a-113j.

Each of the first and second rails 116a-116b comprises a flat rail member 122, and a plurality of rail rods 123a-123d (e.g. wood/plastic/metallic dowels, biscuits of 8 mm length) extending outwardly therefrom. Each of the first and second stiles 114a-114b defines a plurality of blind passageways 124a-124d on a periphery thereof. The plurality of blind passageways 124a-124d receives the plurality of rail rods 123a-123d.

In the illustrated embodiment, the cabinet door 106 comprises an adhesive material 125a-125d between the first and second rails 116a-116b and the first and second stiles 114a-114b. Here, the first and second rails 116a-116b and the first and second stiles 114a-114b are coupled together in 90° butt joints. Of course, in other embodiments, the first and second rails 116a-116b and the first and second stiles 114a-114b may have mitered corners in the alternative. For example, each of the first stile expansion gap 115a, the second stile expansion gap 115b, the first rail expansion gap 117a, and the second rail expansion gap 117b may be about 1 mm in width (i.e. ±0.3 mmm from 1 mm).

Also, the first and second stiles 114a-114b, and the first and second rails 116a-116b may be coupled to the center panel 107 without an adhesive material. The first and second stiles 114a-114b, the first and second rails 116a-116b, and the center panel 107 may comprise a moisture resistant material, for example, wood, such as Accoya wood, cellulose material, or medium-density fiberboard (MDF).

Yet another aspect is directed to a method of making a cabinet door 106 to be coupled to a face frame 103 of a cabinet enclosure 100 and providing access to a cavity 102 for the cabinet enclosure. The method comprises forming a center panel 107 comprising a flat member 110 having first and second sides 111a-111b, and first and second ends 112a-112b extending between the first and second sides, and a plurality of rods 113a-113j extending outwardly from the first and second sides, and the first and second ends. The method also includes forming first and second stiles 114a-114b extending vertically and respectively receiving the plurality of rods 113a-113j extending from the first and second sides 111a-111b of the center panel 107. The first stile 114a and the first side 111a of the center panel 107 define a first stile expansion gap 115a therebetween, and the second stile 114b and the second side 111b of the center panel define a second stile expansion gap 115b therebetween. The method comprises forming first and second rails 116a-116b extending horizontally and respectively receiving the plurality of rods 113a-113j extending from the first and second ends 112a-112b of the center panel 107. The first rail 116a and the first end 112a of the center panel 107 define a first rail expansion gap 117a therebetween, and the second rail 116b and the second end 112b of the center panel define a second rail expansion gap 117b therebetween.

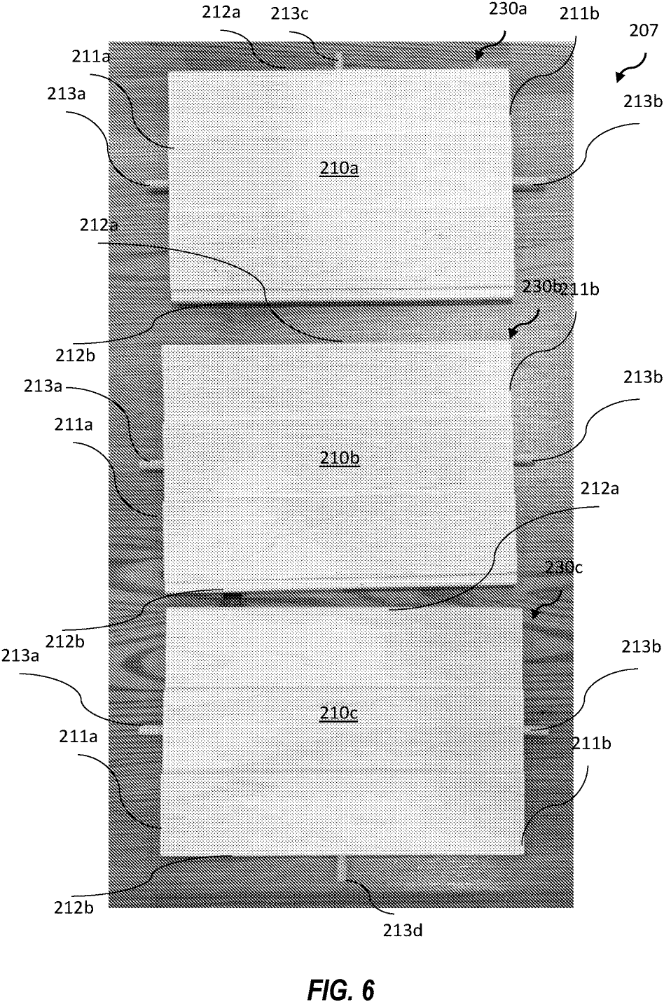

Referring now additionally to FIG. 6, another embodiment of the center panel 207 is now described. In this embodiment of the center panel 207, those elements already discussed above with respect to FIGS. 1-5 are incremented by 100 and most require no further discussion herein. This embodiment differs from the previous embodiment in that this center panel 207 illustratively includes a plurality of center panel segments 230a-230c. Each of the plurality of center panel segments 230a-230c comprises a flat member 210a-210c having first and second sides 211a-111b, and first and second ends 212a-212b extending between the first and second sides. Each of the first and second sides 211a-111b comprises a single lateral rod 213a-213b. Also, the uppermost and lowermost center panel segments 230a & 230c have a first end/second end 212a-212b with a single rod extending single vertical rod 213c-213d. The middle center panel segment 230b may rotate (i.e. acting as a louver) about an axis defined by the single lateral rod 213a-213b.

Current outdoor cabinetry may fail to make sufficient provisions for propane tanks that are frequently used with outdoor cabinetry, for example, in outdoor/summer kitchen applications. The problems with these prior approaches include propane tanks not fitting into the outdoor cabinetry at all, being difficult to install and remove and/or being placed in enclosures without sufficient ventilation. Attempts to overcome this problem by increasing the cabinet height from the standard 34 and ½ inch height (not including the countertop) create problems because the cabinet height may no longer match with appliances that are often included with outdoor cabinetry and may also create a height that is no longer suitable for use with seating or other furniture that is designed to work with standard height cabinets.

Attempting to install propane tanks in outdoor cabinets that are too small also creates substantial difficulties for the user and a lack of sufficient ventilation that can create fire hazards. In an attempt to mitigate the fire hazard associated with enclosures that are too small, current outdoor cabinetry uses cuts/vents in in the base of the cabinet to provide ventilation for propane gases. The currently known approaches to outdoor cabinetry, therefore, result in less useful and/or functional outdoor cabinetry.

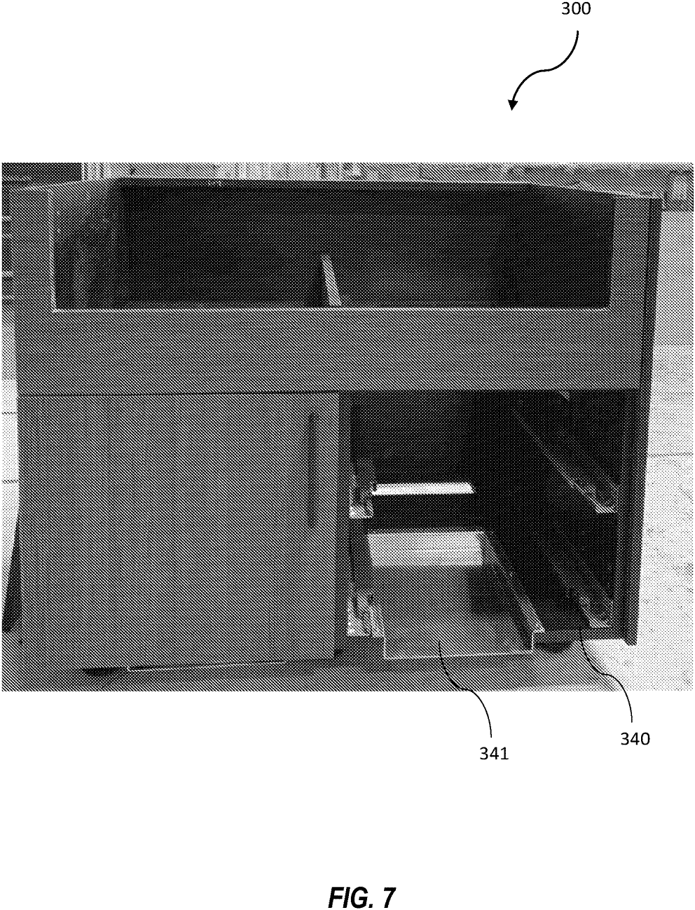

Referring now additionally to FIG. 7, another embodiment of the cabinet enclosure 300 is now described. In this embodiment of the cabinet enclosure 300, those elements already discussed above with respect to FIGS. 1-5 are incremented by 200 and most require no further discussion herein. This embodiment differs from the previous embodiment in that this cabinet enclosure 300 illustratively includes a bottom panel 340 defining a slot 341 for receiving a portable natural gas tank, for example, a 20 lb. propane tank. The slot 341 comprises a C-shaped channel configured to receive a bottom flange of a portable natural gas tank. Helpfully, the natural gas tank can be readily slid into the cavity of the cabinet enclosure 300.

### Floating Center Panel Construction

One of the main challenges in producing durable outdoor cabinetry is overcoming expansion and contraction that causes paint and structural failure. One of the primary culprits is the center panel of cabinet doors that is typically captured in a groove (dado) on all four sides. This captured central panel will expand and contract, often causing the perimeter frame around it to split apart. As can be seen in FIGS. 1-5, this problem can be avoided in the present invention by cutting or otherwise creating a center panel that is smaller than the inside frame dimension to allow room for expansion and contraction. In the preferred embodiment, the center panel is cut or otherwise shaped approximately 1 mm smaller than the inside frame dimensions. Other dimensions can be used in various embodiments so long as they still allow sufficient room for expansion and contraction while also concealing the contents behind the door and providing a solid appearance. The center portion can be a flat panel (See FIGS. 1-5) or other panel variations such as a louvered panel (See FIG. 6). In embodiments without a single panel, multiple pieces may be connected (See FIG. 6) with additional space between the pieces and the surrounding frame to account for the expansion and contraction created by weather conditions. The grooves described below may be modified as necessary to hold multi-piece door panels in the appropriate position.

The center portion may also be attached to the frame using only dowel pins on the panel (without glue) set into grooves on the frame. The grooves may be continuous. In the preferred embodiment, however, they are not continuous around the entire perimeter of the frame. The grooves may start and stop to simplify assembly issues and avoid water retention. One or more of the above features may be combined to produce a panel that freely “floats” inside the frame, thus reducing stress to the surrounding frame and paint on the cabinet door.

### Durable Materials

The materials of the prior outdoor cabinetry are highly susceptible to weather and sun damage and often deteriorate rapidly. To avoid the problems associated with the prior art, the present invention can utilize more durable materials. Such materials include a lumber called Accoya that is a treated, environmentally responsible lumber that is significantly more stable than the lumber used in prior art outdoor cabinetry. A number of mahogany-type woods and certain MDF type materials may also be used in place of Accoya wood in certain embodiments. The door frames (stiles and rails) may also be assembled, preferably with 8 mm dowel pins, and polyurethane glue. Preferably, no glue is used on the center panel.

In certain embodiments, water-based paints may be used that are designed for outdoor exposure. Water based paints designed for outdoor use from NanoChem Technologies Company are used in the preferred embodiment, although water-based paints from other suppliers including Sherwin Williams and PPG Industries, Inc. may also be used. NanoChem Technologies Company has also performed accelerated weather testing proving that the present invention’s combination of Accoya wood and NanoChem paint that will provide durability at a minimum 5 years and up to 15 years or more.

### Material Dimensions

The outdoor cabinetry of the prior art typically uses “compact” or phenolic sheets that are typically 6-12 millimeters (“mm”) thick and are typically used for building facades and decorative exterior architectural details. In certain embodiments of the present invention, these sheets can be made from phenolic sheet materials that are around the range of 15 mm to 19 mm. In the preferred embodiment, the sheets are 16 mm thick. This thickness is suitable for use with various fasteners commonly in use in Europe and provides substantially more durability than the 6-12 mm thickness in use by the prior art.

### Propane Tank Dropdown

Outdoor cabinetry solutions in use to date do not accommodate a built-in grill while also sufficiently fitting a standard 20-pound propane tank and providing sufficient ventilation. A significant limiting factor for cabinets is the 34 and ½ standard height for cabinets (not including the countertop). This standard height limits the amount of space available for propane tanks inside the cabinet.

With reference to FIG. 7, the present invention solves these problems by cutting the bottom out of the grill base cabinet and installing a tray that drops down where the base of the propane tank will be placed. As will be appreciated by those skilled in the art, the central channel can be created in other ways, including by joining pre-cut pieces or creating the channel with a single piece of material such as in in certain aluminum recessed channel embodiments. The preferred embodiment of the present invention utilizes a 1 and ½ inch recessed channel that allows the propane tank to slide into the area and enables it to rest on the channel area. Other dimensions may be used for the recessed area. The recessed channel provides additional space for propane tanks that allow them to be stored vertically inside the cabinet. The additional space created by the recessed channels also makes it easier to install and remove propane tanks.

The recessed channel for the base of the propane tanks may be constructed from PVC (See FIG. 5), wood, aluminum, or other durable materials. The interior of the cabinet base may also be mounted on rails to allow the propane tank to slide out for easier access. The recessed channel may be situated such it extends below the cabinet door to allow for ventilation of propane gases that can create fire hazards. This can be seen in the left door with recessed aluminum channel extending below the door in FIG. 7. Allowing the channel to extend below the door facilitates ventilation. Because propane is heavier than air, the propane will typically rest at the bottom of the cabinet and can be effectively vented with this gap allowing it to escape from the recessed channel below the cabinet door.

In other embodiments, it may be desirable to have a recessed channel that does not extend below the cabinet door. In such embodiments, ventilation may still be achieved with a recessed channel that is shorter than the cabinet depth, thus creating ventilation because the channel does not extend fully forward to the cabinet door and/or does not extend fully back to the back wall of the cabinet.

### Durable Joints and Fasteners

In certain embodiments of the present invention, lock mitered finished ends can be used to fabricate an interlocking edge to match the face of the “compact” material. This lock miter enables the use of clamps to make a secure joint. In certain embodiments, PVC material or other materials that have lesser screw holding properties may be used. For materials that can present durability issues for holding hinges or other hardware, hinge plates and other hardware can be securely fastened using machine screws and “tee nuts”.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A cabinet enclosure comprising:
a cabinet housing defining a cavity therein and having first and second end panels, and a back panel coupled to the first and second end panels; and
at least one cabinet door coupled to the first and second end panels opposite the back panel and providing access to the cavity, the at least one cabinet door comprising
a center panel comprising
a flat member having first and second sides, and first and second ends extending between the first and second sides, and
a plurality of rods extending outwardly from the first and second sides, and the first and second ends,
first and second stiles extending vertically and respectively receiving the plurality of rods extending from the first and second sides of the center panel, the first stile and the first side of the center panel defining a first stile expansion gap therebetween, the second stile and the second side of the center panel defining a second stile expansion gap therebetween, and
first and second rails extending horizontally and respectively receiving the plurality of rods extending from the first and second ends of the center panel, the first rail and the first end of the center panel defining a first rail expansion gap therebetween, the second rail and the second end of the center panel defining a second rail expansion gap therebetween.

2. The cabinet enclosure of claim 1 wherein each of the first and second stiles defines a stile longitudinal slot on a periphery thereof for receiving the plurality of rods extending from the first and second sides of the center panel.

3. The cabinet enclosure of claim 1 wherein each of the first and second rails defines a rail longitudinal slot on a periphery thereof for receiving the plurality of rods extending from the first and second ends of the center panel.

4. The cabinet enclosure of claim 1 wherein each of the first and second rails comprises a flat rail member, and a plurality of rail rods extending outwardly therefrom.

5. The cabinet enclosure of claim 4 wherein each of the first and second stiles defines a plurality of blind passageways on a periphery thereof, the plurality of blind passageways receiving the plurality of rail rods.

6. The cabinet enclosure of claim 1 wherein the at least one cabinet door comprises an adhesive material between the first and second rails and the first and second stiles.

7. The cabinet enclosure of claim 1 wherein each of the first stile expansion gap, the second stile expansion gap, the first rail expansion gap, and the second rail expansion gap is about 1 mm in width.

8. The cabinet enclosure of claim 1 wherein the first and second stiles, and the first and second rails are coupled to the center panel without an adhesive material.

9. The cabinet enclosure of claim 1 wherein the first and second stiles, the first and second rails, and the center panel comprise a moisture absorbing material.

10. A cabinet door to be coupled to a cabinet enclosure and providing access to a cavity for the cabinet enclosure, the cabinet door comprising:
a center panel comprising
a flat member having first and second sides, and first and second ends extending between the first and second sides, and
a plurality of rods extending outwardly from the first and second sides, and the first and second ends;
first and second stiles extending vertically and respectively receiving the plurality of rods extending from the first and second sides of the center panel, the first stile and the first side of the center panel defining a first stile expansion gap therebetween, the second stile and the second side of the center panel defining a second stile expansion gap therebetween; and
first and second rails extending horizontally and respectively receiving the plurality of rods extending from the first and second ends of the center panel, the first rail and the first end of the center panel defining a first rail expansion gap therebetween, the second rail and the second end of the center panel defining a second rail expansion gap therebetween.

11. The cabinet door of claim 10 wherein each of the first and second stiles defines a stile longitudinal slot on a periphery thereof for receiving the plurality of rods extending from the first and second sides of the center panel.

12. The cabinet door of claim 10 wherein each of the first and second rails defines a rail longitudinal slot on a periphery thereof for receiving the plurality of rods extending from the first and second ends of the center panel.

13. The cabinet door of claim 10 wherein each of the first and second rails comprises a flat rail member, and a plurality of rail rods extending outwardly therefrom.

14. The cabinet door of claim 13 wherein each of the first and second stiles defines a plurality of blind passageways on a periphery thereof, the plurality of blind passageways receiving the plurality of rail rods.

15. The cabinet door of claim 10 further comprising an adhesive material between the first and second rails and the first and second stiles.

16. The cabinet door of claim 10 wherein each of the first stile expansion gap, the second stile expansion gap, the first rail expansion gap, and the second rail expansion gap is about 1 mm in width.

17. The cabinet door of claim 10 wherein the first and second stiles, and the first and second rails are coupled to the center panel without an adhesive material; and wherein the first and second stiles, the first and second rails, and the center panel comprise a moisture absorbing material.

18. A method of making a cabinet door to be coupled to a cabinet enclosure and providing access to a cavity for the cabinet enclosure, the method comprising:
forming a center panel comprising
a flat member having first and second sides, and first and second ends extending between the first and second sides, and
a plurality of rods extending outwardly from the first and second sides, and the first and second ends;
forming first and second stiles extending vertically and respectively receiving the plurality of rods extending from the first and second sides of the center panel, the first stile and the first side of the center panel defining a first stile expansion gap therebetween, the second stile and the second side of the center panel defining a second stile expansion gap therebetween; and
forming first and second rails extending horizontally and respectively receiving the plurality of rods extending from the first and second ends of the center panel, the first rail and the first end of the center panel defining a first rail expansion gap therebetween, the second rail and the second end of the center panel defining a second rail expansion gap therebetween.

19. The method of claim 18 wherein each of the first and second stiles defines a stile longitudinal slot on a periphery thereof for receiving the plurality of rods extending from the first and second sides of the center panel.

20. The method of claim 18 wherein each of the first and second rails defines a rail longitudinal slot on a periphery thereof for receiving the plurality of rods extending from the first and second ends of the center panel.
